(19) United States
(12) Patent Application Publication
(10) Pub. No.: US 2025/0351089 A1
(43) Pub. Date: Nov. 13, 2025

(54) CW POWER, FREQUENCY AND BEAM CONTROL FOR AMBIENT IOT

(71) Applicant: Nokia Technologies Oy, Espoo (FI)

(72) Inventors: Nuno Manuel KIILERICH PRATAS, Aalborg (DK); Oana-Elena BARBU, Aalborg (DK); Benny VEJLGAARD, Gistrup (DK); Johannes HARREBEK, Aalborg (DK); Simon SVENDSEN, Aalborg (DK)

(73) Assignee: Nokia Technologies Oy, Espoo (FI)

(21) Appl. No.: 19/201,167

(22) Filed: May 7, 2025

(30) Foreign Application Priority Data
May 10, 2024 (GB) 2406650.8

(51) Int. Cl. H04W 52/14; H04B 1/713; H04B 7/0426; H04W 68/00; H04W 76/25

(52) U.S. Cl. CPC H04W 52/146; H04B 1/713; H04B 7/0426; H04W 68/00; H04W 76/25

(57) ABSTRACT

An apparatus is provided which comprises at least one processor, and at least one memory storing instructions that, when executed by the at least one processor, cause the apparatus at least to: receive a carrier wave transmission modulated by an ambient internet of things device in an ambient internet of things session, determine whether a received power of the carrier wave transmission is below a predetermined threshold; and in response to determination that the received power is below the predetermined threshold, prepare a notification requesting to control at least one carrier wave transmission characteristic such that the received power is increased, and transmit the notification to a carrier wave provider transmitting the carrier wave transmission or to a session control unit controlling the ambient internet of things session.

### FIELD OF THE INVENTION

The present invention relates to an apparatus, a method and a computer program product for realizing a carrier wave (CW) power, frequency and beam control for ambient IoT.

### RELATED BACKGROUND ART

The following meanings for the abbreviations used in this specification apply:
AIoT ambient IoT
CE control element
CW carrier wave
D2R device to reader
DL downlink
IE information element
IoT Internet of things
L1/2 layer 1/2
MAC medium access control
NAS non-access stratum
NW network
PUCCH physical uplink control channel
PUSCH physical uplink shared channel
R2D reader to device
RACH random access channel
RRC radio resource control
SR scheduling request
SCU session control unit
UE-user equipment
UL uplink

Example embodiments, although not limited to this, relate to ambient Internet of Things (AIoT, sometimes also abbreviated as AIOT or A-IoT). A corresponding system comprises an AIoT device, an activator, a reader and a CW provider (also referred to as CW node or CW signal provider), which are controlled by a SCU (session control unit), for example.

In such a scenario, a carrier wave (CW) is used by the AIoT device to modulate and backscatter an AIoT reply (a D2R signal). The CW signal is different from the activation signal (a R2D signal) and has the main purpose of carrying the AIoT transmission for those AIoT devices which cannot actively and independently generate a signal of their own i.e., device type 1 and 2a. In other words, the CW is being transformed by the AIoT device, to contain the AIoT payload (e.g. ID, data and other control info) and reflected i.e., backscattered either immediately or with a delay pre-configured by the activator via R2D signal configuration.

In such a scenario, it would be beneficial to improve the control of the network elements or network nodes involved.

### SUMMARY OF THE INVENTION

Example embodiments address this situation aim to provide an improved control of network elements or network nodes involved in a AIoT session.

Several aspects of the various example embodiments will be described with respect to certain aspects. These aspects are not intended to indicate key or essential features of the various example embodiments, nor are they intended to be used to otherwise limit the scope of the subject disclosure. Other features, aspects and elements of the various example embodiments will be readily apparent to a person skilled in the art in view of the subject disclosure.

According to a first aspect, an apparatus is provided which comprises
at least one processor, and
at least one memory storing instructions that, when executed by the at least one processor, cause the apparatus at least to:
receive a carrier wave transmission modulated by an ambient internet of things device in an ambient internet of things session,
determine whether a received power of the carrier wave transmission is below a predetermined threshold; and
in response to determination that the received power is below the predetermined threshold, prepare a notification requesting to control at least one carrier wave transmission characteristic such that the received power is increased, and transmit the notification to a carrier wave provider transmitting the carrier wave transmission or to a session control unit controlling the ambient internet of things session.

According to a second aspect, a method is provided which comprises
receiving a carrier wave transmission modulated by an ambient internet of things device in an ambient internet of things session,
determining whether a received power of the carrier wave transmission is below a predetermined threshold; and
in response to determination that the received power is below the predetermined threshold, preparing a notification requesting to control at least one carrier wave transmission characteristic such that the received power is increased, and transmitting the notification to a carrier wave provider transmitting the carrier wave transmission or to a session control unit controlling the ambient internet of things session.

According to a third aspect, a computer program product is provided which comprises code means for performing the method according to the second aspect when run on a processing means or module.

According to a fourth aspect, an apparatus is provided which comprises:
means for receiving a carrier wave transmission modulated by an ambient internet of things device in an ambient internet of things session,
means for determining whether a received power of the carrier wave transmission is below a predetermined threshold; and
means for, in response to determination that the received power is below the predetermined threshold, preparing a notification requesting to control at least one carrier wave transmission characteristic such that the received power is increased, and transmitting the notification to a carrier wave provider transmitting the carrier wave transmission or to a session control unit controlling the ambient internet of things session.

Advantageous developments are defined in the dependent claims.

### BRIEF DESCRIPTION OF THE DRAWINGS

These and other objects, features, details and advantages will become more fully apparent from the following detailed description of example embodiments, which is to be taken in conjunction with the appended drawings, in which:

FIG. 1A shows an SCU 1 according to an example embodiment,

FIG. 1B shows a procedure carried out by the SCU 1 according to the example embodiment,

FIG. 2A shows a CW provider 2 according to an example embodiment,

FIG. 2B shows a procedure carried out by the CW provider 2 according to the example embodiment,

FIG. 3A shows a reader 3 according to an example embodiment,

FIG. 3B shows a procedure carried out by the reader 3 according to the example embodiment,

FIG. 4A shows a network entity 4 according to an example embodiment,

FIG. 4B shows a procedure carried out by the network entity 4 according to the example embodiment,

FIG. 5A shows a UE 5 according to an example embodiment,

FIG. 5B shows a procedure carried out by the UE 5 according to the example embodiment,

FIG. 6 shows a signalling diagram according to an embodiment Z,

FIG. 7 shows a signalling diagram according to an embodiment A,

FIG. 8 shows a signalling diagram according to an embodiment B, and

FIG. 9 shows a signalling diagram according to an embodiment C.

### DETAILED DESCRIPTION OF EXAMPLE EMBODIMENTS

In the following, description will be made to example embodiments. It is to be understood, however, that the description is given by way of example only, and that the described example embodiments are by no means to be understood as limiting the present invention thereto.

Before describing example embodiments, in the following, a technical context of example embodiments and problems of the prior art are discussed in some more detail.

Some example embodiments relate to AIoT (ambient Internet of Things). A SCU (session control unit) may control an AIoT session which involves a AIoT device, an activator, a reader and a CW provider (also referred to as CW node or CW signal provider). As mentioned above, a carrier wave (CW) is a wave used by the AIoT device to modulate and backscatter a AIoT reply (a D2R signal). The CW signal is different from the activation signal (a R2D signal) and has the main purpose of carrying the AIoT transmission for those AIoT devices which cannot actively and independently generate a signal of their own i.e., device type 1 and 2a. In other words, the CW is being transformed by the AIoT device, to contain the AIoT payload (e.g. ID, data and other control info) and reflected i.e., backscattered either immediately or with a delay pre-configured by the activator via R2D signal configuration.

The CW provider, i.e., the entity generating the CW should: a) be in the proximity of the AIoT device, and b) transmit the CW with sufficient power on the correct carrier frequency and for sufficiently long time, so that the AIoT device can modulate all its payload onto said CW and, its reply can be successfully decoded by a reader.

Since the configuration of the CW node is paramount to the success of the AIoT session, RAN1 discussed introducing a separate entity for this sole purpose, where this entity may be part of either topology 1 or 2 or may be outside the topology. Furthermore, because the CW transmission can be potentially harmful to other ongoing transmissions—either AIoT or Uu traffic, its configuration should be done by the NW or by the entities participating in the AIoT session as highlighted in the Proposal 2.4-2a, which can be found in FL summary (R1-2403767) on CW waveform characteristics for A-IoT for A.I. 9.4.2.4 at 3GPP TSG RAN WG1 #116bis, and is reproduced in the following:

Proposal 2.4-2a: From RAN1 perspective, a control of at least the following CW characteristics should be performed:
Timing (e.g., when CW is transmitted or not transmitted, Time resources)
Transmission Power
Frequency resources (includes bandwidth)
Spectrum
Which CW node to transmit (outside of topology)
frequency hopping patterns
Beam or directional transmission if the CW supports it.

In some example embodiments, it is addressed how to associate CW signal provider(s) with the AIoT session devices and how to control the power, frequency hopping and spatial transmission of the CW signal provider.

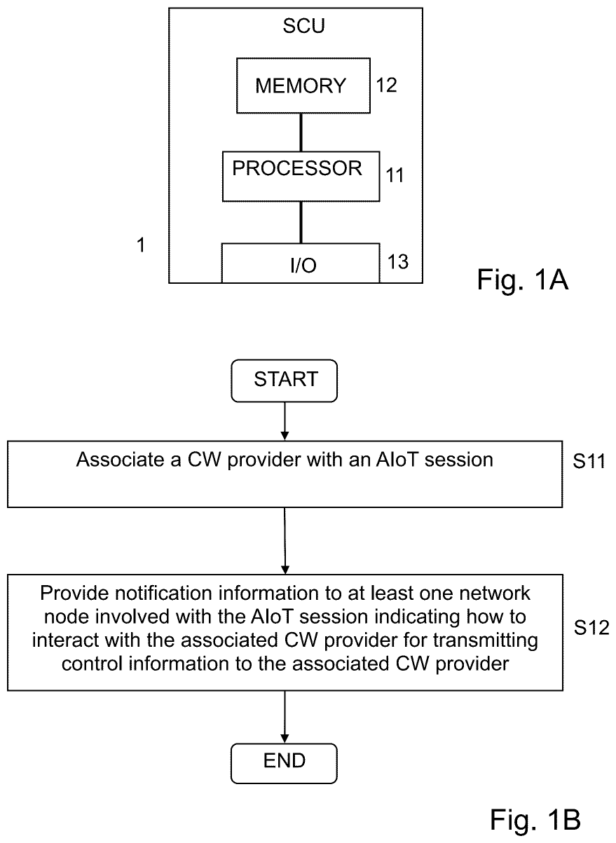

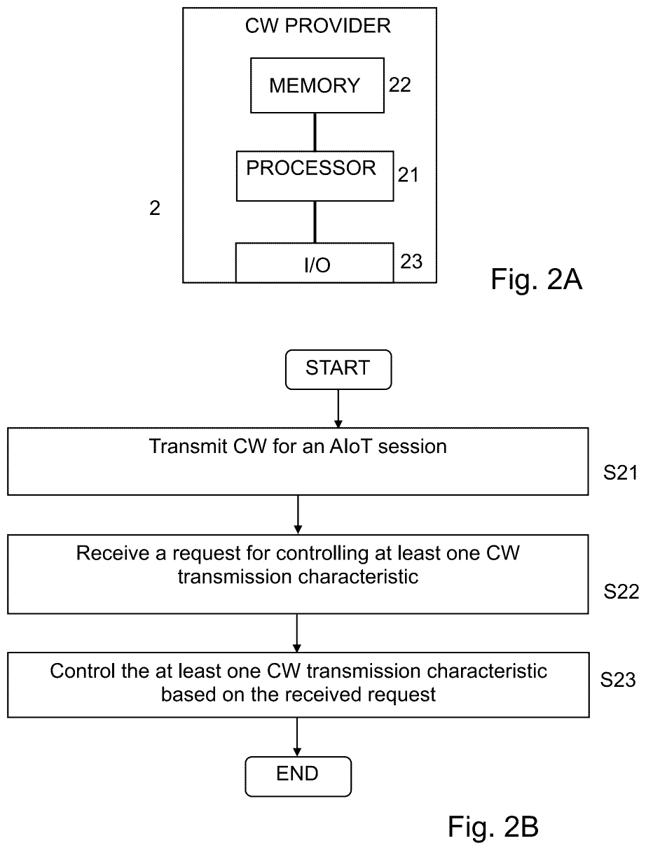

In the following, a general overview of some example embodiments is described by referring to FIGS. 1A, 1B, 2A and 2B.

FIG. 1A shows an SCU 1 according to the present example embodiment. The SCU 1 is an example for an apparatus, which may be or be a part of a network node or network element carrying out a function or role of a session control unit, for example. A procedure carried out by the SCU 1 is illustrated in FIG. 1B. The LMF 1 shown in FIG. 1A comprises at least one processor 11 and at least one memory 12 storing instructions that, when executed by the at least one processor 11, cause the apparatus to: associate a carrier wave provider with an ambient internet of things (AIoT) session, wherein the carrier wave provider is a network node configured to transmit a carrier wave, and the ambient internet of things session involves an ambient internet of things device being a network node configured to receive the carrier wave and manipulate the carrier wave transmitted by the carrier wave provider (S11 in FIG. 1B); and provide notification information to at least one network node involved in the ambient internet of things session, wherein the notification information indicates how to interact with the carrier wave provider for transmitting control information to the associated carrier wave provider (S12 in FIG. 1B).

FIG. 2A shows a CW provider 2 according to the present example embodiment. The CW provider 2 is an example for an apparatus, which may be or be a part of a network node or network element carrying out a function or role of a carrier wave provider, for example. A procedure carried out by the CW provider 2 is illustrated in FIG. 2B. The CW provider 2 shown in FIG. 2A comprises at least one processor 21 and at least one memory 22 storing instructions that, when executed by the at least one processor 21, cause the apparatus to: transmit a carrier wave for an ambient internet of things session involving an ambient internet of things device being a network node configured to receive the carrier wave and manipulate the carrier wave (S21 in FIG. 2B), receive a request for controlling at least one carrier wave transmission characteristic (S22 in FIG. 2B), and control the at least one carrier wave transmission characteristic based on the received request such that the at least one carrier wave transmission characteristic is changed.

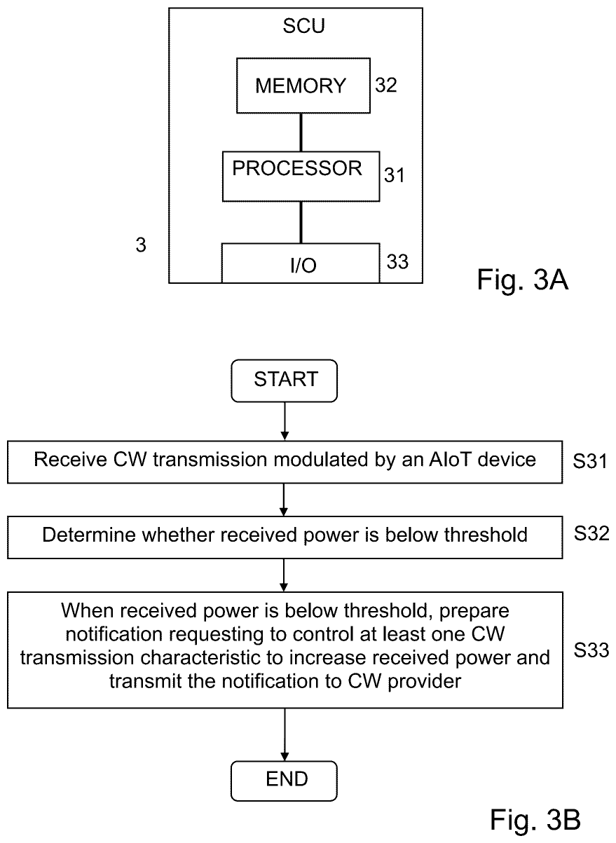

FIG. 3A shows a reader 3 according to the present example embodiment. The reader 3 is an example for an apparatus, which may be or be a part of a network node or network element carrying out a function or role of a reader in an AIoT session, for example. A procedure carried out by the reader 3 is illustrated in FIG. 3B. The reader 3 shown in FIG. 3A comprises at least one processor 31 and at least one memory 32 storing instructions that, when executed by the at least one processor 31, cause the apparatus to: receive a carrier wave transmission modulated by an ambient internet of things device in an ambient internet of things session (S31 in FIG. 3B), determine whether a received power of the carrier wave transmission is below a predetermined threshold (S32 in FIG. 3B); and, in response to determination that the received power is below the predetermined threshold, prepare a notification requesting to control at least one carrier wave transmission characteristic such that the received power is increased, and transmit the notification to a carrier wave provider transmitting the carrier wave transmission or to a session control unit controlling the ambient internet of things session (S33 in FIG. 3B).

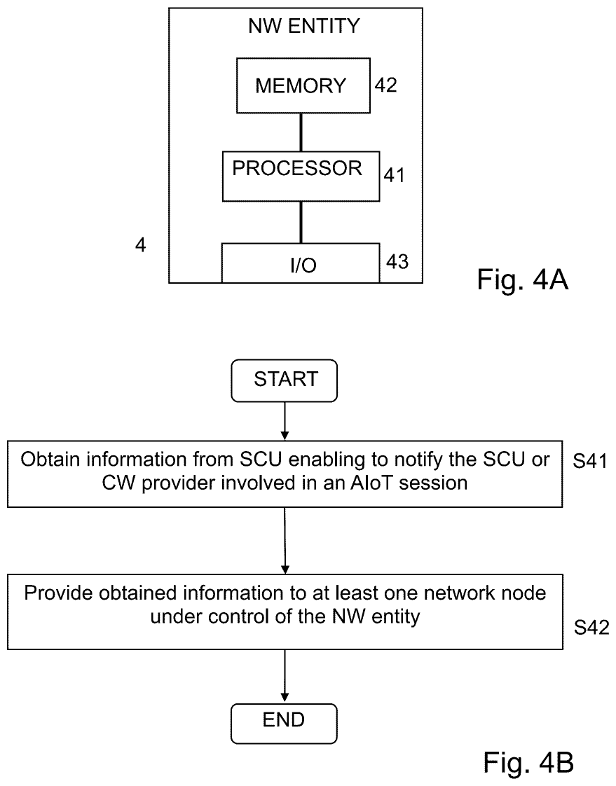

FIG. 4A shows a NW entity 4 according to the present example embodiment. The NW entity 4 is an example for an apparatus, which may be or be a part of a network control element outside of an AIoT session, for example. For example, the NW entity 4 can be a gNB controlling a connection to a network node such as a UE. A procedure carried out by the NW entity 4 is illustrated in FIG. 4B. The NW entity 4 shown in FIG. 4A comprises at least one processor 41 and at least one memory 42 storing instructions that, when executed by the at least one processor 41, cause the apparatus to: obtain information, from a session control unit (e.g., SCU 1 shown in FIG. 1A) controlling a ambient internet of things session, which enables notifying the session control unit or a carrier wave provider (e.g., CW provider 2 shown in FIG. 2A) involved in the ambient internet of things session concerning a carrier wave transmission and identifying the carrier wave transmission (S41 in FIG. 4), and provide the obtained information to at least one network node, wherein the at least one network node is under control of said apparatus (S42 in FIG. 4).

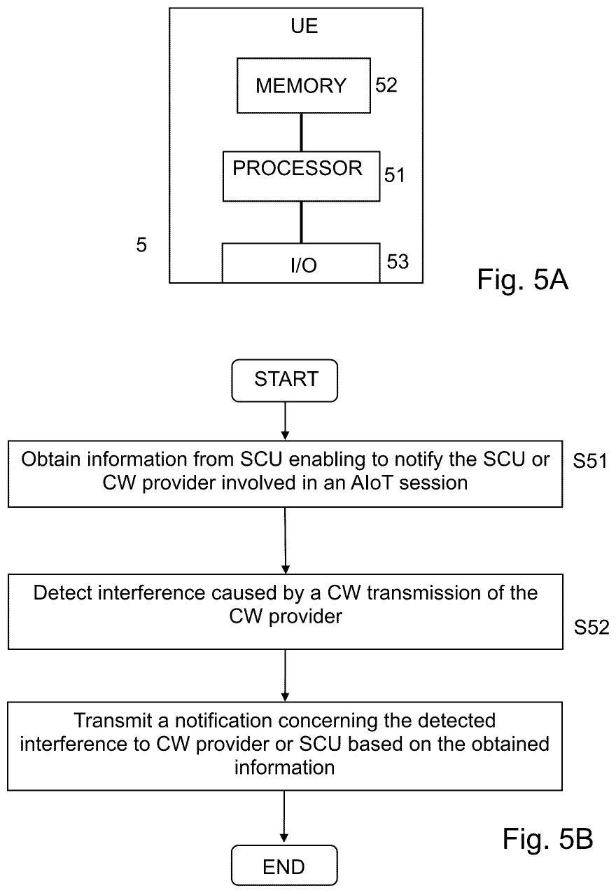

FIG. 5A shows a UE 5 according to the present example embodiment. The UE 5 is an example for an apparatus, which may be or be a part of a network node or network element carrying out a function or role of a user equipment, for example. A procedure carried out by the UE 5 is illustrated in FIG. 4B. The UE 5 shown in FIG. 5A comprises at least one processor 51 and at least one memory 52 storing instructions that, when executed by the at least one processor 51, cause the apparatus to: obtain information from a session control unit (e.g., SCU 1 shown in FIG. 1A) controlling a ambient internet of things session, which enables notifying the session control unit or a carrier wave provider (e.g., CW provider 2 shown in FIG. 2A) involved in controlling the ambient internet of things session concerning a carrier wave transmission, and identifying the carrier wave transmission (S51 in FIG. 5B), detect interference affecting the apparatus caused by the carrier wave transmission (S52 in FIG. 5B), and transmit a notification concerning the detected interference to the carrier wave provider or the session control unit based on the obtained information (S53 in FIG. 5C).

Hence, according to several example embodiments, mechanisms are provided by which it is possible to assign a CW signal provider to an AIoT session and to control radiated power from the CW signal provider.

The apparatuses 1 to 5 shown in FIGS. 1A, 2A, 3A, 4A and 5A may comprise more components than described above, and may further comprise I/O units 13, 23, 33, 43, 53 which are capable of transmitting to and receiving from other network elements.

An AIoT session as described above, which may be controlled or supervised by a session control unit (SCU) may involve an ambient internet of things (AIoT) device being a network node configured to receive a carrier wave transmitted from a CW provider and manipulate the carrier wave, a reader (e.g., the reader 3 shown in FIG. 3) being a network node configured to receive the manipulated carrier wave, and an activator being a network node configured to transmit an activation signal to the AIoT device instructing the AIoT device to start manipulating the carrier wave.

The transmission of the carrier wave may be controlled/adapted by controlling at least one characteristic thereof. The at least one carrier wave transmission characteristic (CW transmission characteristic) may comprise transmission power, frequency hopping and/or transmission beamforming. For example, a received power at the reader 3 may be increased by increasing the transmission power, and/or by changing/adapting frequency hopping patterns and/or transmission beamforming. Interference caused by the CW transmission and experienced at the UE 5, for example, may be reduced by reducing the transmission power and/or by correspondingly changing/adapting frequency hopping and/or transmission beamforming at the CW provider.

In the following, some example embodiments are described more detail.

According to some example embodiments, a solution to the configuration of proximal CW signal providers to the AIoT session (with support from a Session Control Unit (SCU)) is provided, and a way to control radiated power from the CW signal provider by controlling transmission, frequency hopping and spatial transmission is provided.

In the following, as an embodiment A, an AIoT session configuration with association of CW provider to the session is described.

In this embodiment, two scenarios for a CW provider control are considered. The first is a SCU mediated CW provider control. In this control, a network node attempting to interact with the CW provider will do this via the SCU. That is, in this case there is an indirect connection between the network node and the CW provider. The second scenario is a direct CW provider control. In this scenario, the network node attempting to interact with the CW provider is capable and enabled to interact with the CW provider directly. That is, in this case there is a direct connection between the network node and the CW provider.

According to embodiment A, an identification of the CW provider(s) associated with the AIoT session is carried out. In case of a SCU mediated CW provider control, this identification can consist of the exchange of a dedicated CW identifier that becomes known between the SCU and AIoT session members (activator, AIoT device and/or reader). In case of a direct CW provider control, the identification can consist of the exchange of a dedicated CW identifier (e.g. sidelink L1/2 identifier, or sidelink service identifier).

Moreover, a proximity between CW provider and AIoT session members (specifically proximity to the AIoT device) is determined by the SCU (e.g. based on positioning information, based on the exchange measurements between the CW and AIoT session members or based on sidelink based discovery where the discovery results have been shared with the SCU).

Moreover, a configuration for the activator and/or reader to be able to request specific actions from the CW provider (e.g. directly to the CW provider or via the SCU) is provided.

In case of the SCU mediated power control, this configuration can consist of the exchange of a dedicated SR/PUCCH configuration that can be used by the AIoT session members to indicate the need for control of transmission characteristics (e.g. transmission power, frequency hopping and/or transmission beamforming) of the CW provider. The actual control information can be provided via payload of the PUCCH, MAC CE, RRC IE and/or NAS IE. The content of the control information can be at least one of:
Power control: Power increase/decrease step and/or absolute power level configuration,
Frequency Hopping: Change of frequency hopping sequence, masking of certain hops (i.e. zero-power transmission on the identified hops);
Tx Beamforming: Identification of spatial filters (i.e. beam IDs), where there should be a power increase/decrease;
Duty cycle: Increase/decrease the duty cycle of the transmitted CW;

In case of the direct CW provider control) configuration for the activator and/or reader to be able to request specific actions from the CW provider can consist of dedicated sidelink configuration including the resource pool to use, DRX configuration associated with CW provider, L1/2 ID or service ID to use to contact the CW provider.

In the following, an embodiment B is described, in which a notification of the need for reduction of the CW signal transmission power to minimize interference is carried out.

For this, at first a notification by an impacted UE (or an impacted NW entity) to a NW entity or SCU regarding interference regarding interference experienced by a UE outside the AIoT session due to a CW provider transmission to a NW entity or SCU is described. It is noted that in this example, an impacted UE (or a victim UE) is described. However, this is only an example and can be any node impacted by the interference. In the following, such a node is also referred to as interference impacted node [This term is used in the figures].

The victim UE may detect the source of interference if the CW signal signature has been made known in advance to the victim UE by the NW. By knowing the CW signal, the victim UE can identify its contribution to the total receive signal, but also implicitly identify the CW provider-assuming a unique mapping between CW provider and CW signal. The CW signal configuration may be distributed by the NW to all UEs in the cell via SIB, or alternatively, to a set of expected victim UEs. Details are described in embodiment Z described later.

This notification includes information about:
the received interference power and the suggested power reduction;
past time and frequency resources where this interference has been observed; —(when available to the UE) the future time and frequency resources where this interference level should be avoided (e.g. when these are known due to upcoming UL/DL grants and/or configured with SPS or CG-SDT);
traffic priority (e.g. associated QoS profile, such as the 5G QoS Identifier 5QI).

Moreover, the victim UE (or a network node controlling the victim UE such as gNB) can issue a request to control of the CW provider transmission characteristics based on the interference notification. This control order (i.e., the request) can be provided via the SCU that is responsible for the CW provider orchestration (which assumes that the node impacted with interference provides the interference notification to the SCU). It is noted that the decision on whether to apply the power reduction will be based on the comparison between the traffic priority of the AIoT session and the traffic priority of the impacted UE. The triggering of the power reduction can also be dependent on whether the power reduction still results in a power that is above a minimum operating power range for the charging/activation of the AIoT device.

The above described control request can be provided directly from a NW entity (e.g. the one serving the impacted UE) towards the CW provider. This assumes that the CW provider can be reached by the NW entity either via Uu (when the CW provider is a UE) or Xn interface (when the CW provider is a network element). Moreover, this control request can also be provided directly from the impacted UE to the UE serving as CW provider when it is possible to establish a sidelink between these UEs.

In the following, a control of the CW transmission characteristics in order to minimize the interference impact is described. In particular, the applied control to the transmission characteristics can be a backoff of the transmission power according with the notification request, avoidance of the time and frequency resources indicated in the interference notification (e.g. alteration or muting of the relevant hops in the frequency hopping pattern); and/or deactivation or power backoff in beamformers provided at the CW provider associated with the direction of the interference impacted node.

In the following, an embodiment C is described, according to which a notification of the need for power increase of the CW transmission due to weak backscattered signal observed at the receiver (in the following also referred to as a “too weak signal notification”) is transmitted.

The notification indicates that the reader is not able to receive a strong enough CW signal and therefore any backscattered signal is also too weak to be decoded. It is noted that here it is assumed that both the CW and AIoT device transmissions are in line of sight with the reader, as the AIoT session should in general be composed of devices that are in proximity of each other. In this case, the reader can determine if the CW power needs to be increased based on the comparison of the received backscattered signal strength and the original CW signal. In Non-Line of Sight conditions, the same approach can be applied, however there will be less correlation between a received low power CW transmission, so any CW transmission characteristics adaptation based on the request from the reader will be less reliable.

Based on the too weak signal notification described above, a request to control of the CW provider transmission characteristics is provided. This control order can be provided via the SCU that is responsible for the CW provider orchestration, where the notification is provided to the SCU (following the configuration details in Embodiment A). Alternatively, this control request can be provided directly from the impacted UE to the UE serving a CW provider when it is possible to establish a sidelink between these UEs (according with the configuration details in Embodiment A).

Then, the CW transmission characteristics can be controlled in order to increase the received CW signal. The applied control to the transmission characteristics can be:
Ramp-up of the transmission power according with the weak signal notification;
Ramp-up of the power in the time and frequency resources indicated in the weak signal notification;
Ramp-up of the transmission power in the beamformers associated with the direction of the interference impacted node.

In the following, an embodiment Z is described, according to which a configuration on how to access the SCU associated with a CW to notify of excess interference is provided.

In particular, a configuration on how to reach the CW provider regarding interference issues is provided. For a given area (i.e. cell or gNB coverage area), the information of which SCU to contact in case of interference is part of the Uu (either common or dedicated) RRC configuration. For example, a dedicated SR/PUCCH configuration can be used to provide this notification. In this case, the assumption is that the dedicated Scheduling Request SR/PUCCH configuration is related to the CW provider or to mechanism that triggers adaptation in the CW provider. In this later case, it would mean that the reader just sends the notification and then the SCU figures out which CW provider(s) need to act on this notification.

Alternatively, this notification can be provided via the RACH procedure, where dedicated PRACH preambles are assigned to this use case or the PUSCH content of the RACH transmission includes information about this notification, e.g. in the form a MAC CE, RRC IE and/or NAS IE.

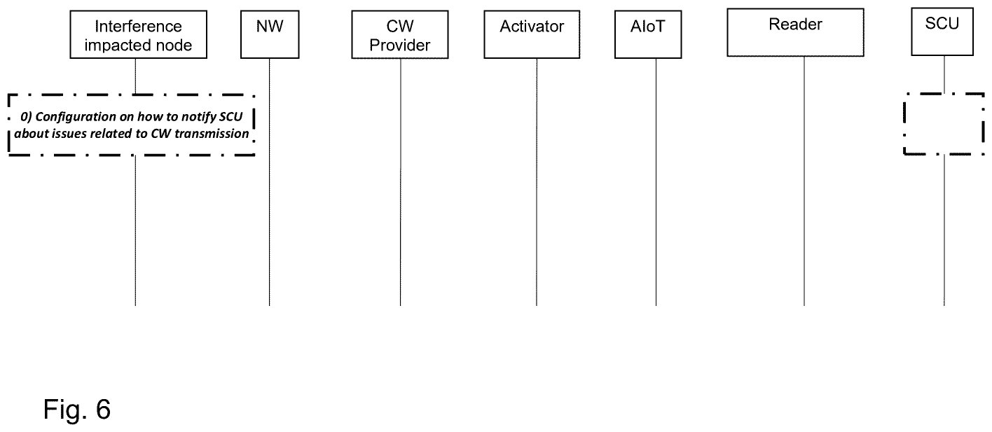

In the following, the embodiments described above are described in some more detail by referring signalling flows depicted in FIGS. 6 to 9.

In particular, FIGS. 6 to 9 show signalling flows between an SCU, a reader, an AIoT device, an activator, a CW provider, a NW (network node, e.g. a gNB) and an interference impacted node (e.g., a UE). The reader, the AIoT device, the activator and the CW provider may be involved in an AIoT session controlled/supervised by the SCU. The NW and the interference impacted nodes are examples for network nodes outside the AIoT session.

FIG. 6 illustrates embodiment Z described above. In process 0), a configuration on how to reach the CW provider regarding interference issues is provided. As mentioned above, for a given area (i.e. cell or gNB coverage area), the information of which SCU to contact in case of interference is part of the Uu (either common or dedicated) RRC configuration. For example, a dedicated SR/PUCCH configuration can be used to provide this notification. Alternatively, this notification can be provided via the RACH procedure, where dedicated PRACH preambles are assigned to this use case or the PUSH content of the RACH transmission includes information about this notification, e.g. in the form a MAC CE, RRC IE and/or NAS IE.

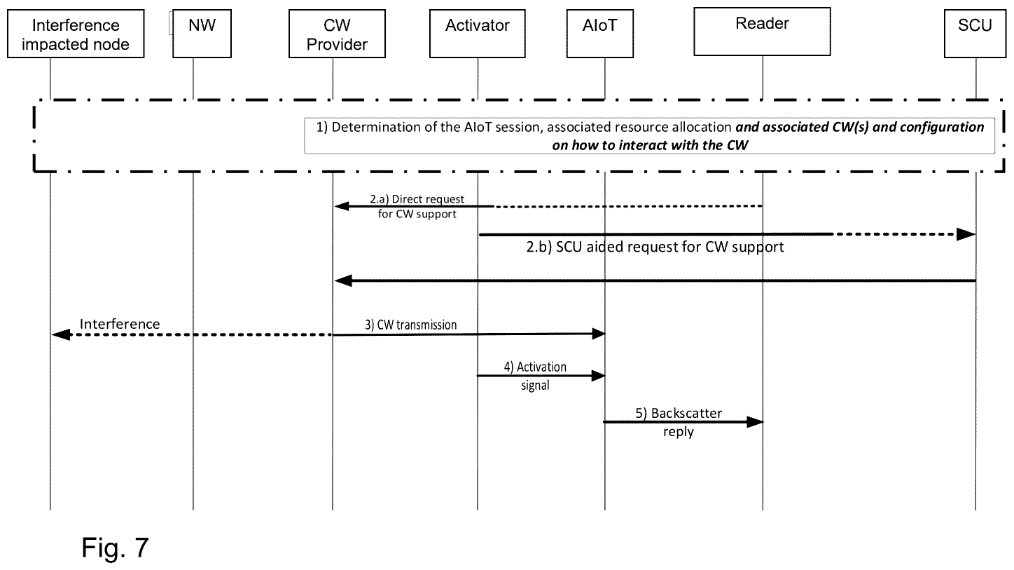

FIG. 7 illustrates embodiment A described above, according to which a SCU aided AIoT session configuration is carried out, which includes the determination of which specific nodes will take the role of activator, reader and CW provider (e.g. based on proximity to the AIoT device) and the resources to be used for the AIoT session, as indicated in process 1.

The AIoT session configuration aspects related to the CW interaction during the AIoT session comprise an identification of the CW provider(s) associated with the AIoT session and a configuration for the activator and/or reader to be able to request specific actions from the CW provider.

Firstly, the identification of the CW provider(s) associated with the AIoT session is described. This identification can consist of the exchange of a dedicated CW identifier that becomes known between the SCU and AIoT session members (activator and/or reader) in case of SCU mediated CW provider control. Alternatively, in case of a direct CW provider control, a dedicated CW identifier (e.g. sidelink L1/2 identifier, or sidelink service identifier) can be exchanged.

A determination of proximity between CW provider and AIoT session members is determined by the SCU (e.g. based on positioning information, based on the exchange measurements between the CW and AIoT session members or based on sidelink based discovery where the discovery results have been shared with the SCU).

In the following, the configuration for the activator and/or reader to be able to request specific actions from the CW provider (e.g. directly to the CW provider or via the SCU) is described.

In case of the SCU mediated CW provider control, the configuration can consist of the exchange of dedicated SR/PUCCH configuration that can be used by the AIoT session members to indicate the need for control of transmission characteristics (e.g. transmission power, frequency hopping and/or transmission beamformer) of the CW provider. The actual control information can be provided via payload of the PUCCH, MAC CE, RRC IE and/or NAS IE. The content of the control information can be at least:
Power control: Power increase/decrease step;
Frequency Hopping: Change of frequency hopping sequence, masking of certain hops (i.e. zero-power transmission on the identified hops);
Tx Beamforming: Identification of spatial filters (i.e. beam IDs), where there should be a power increase/decrease;
Duty cycle: Increase/decrease the duty cycle of the transmitted CW;
In case of the direct CW provider control, the above configuration can consist of the exchange of a dedicated sidelink configuration including the resource pool to use, DRX configuration associated with CW provider, L1/2 ID or service ID to use to contact the CW provider.

In process 2), it is assumed that the activator/reader needs to contact the CW provider. That is, a request for CW support can be done directly between activator/reader and CW provider, as indicated by process 2.a. Otherwise, this can be carried out via the SCU, as shown in process 2.b.

In process 3), the CW transmission is started. It is noted that the assumption is that the CW continues its transmission during at least the AIoT session.

In process 4), the activator transmits its activation signal.

In process 5), the AIoT device, upon receiving the activation signal from the activator, starts the transmission of its backscatter signal on top of the CW signal.

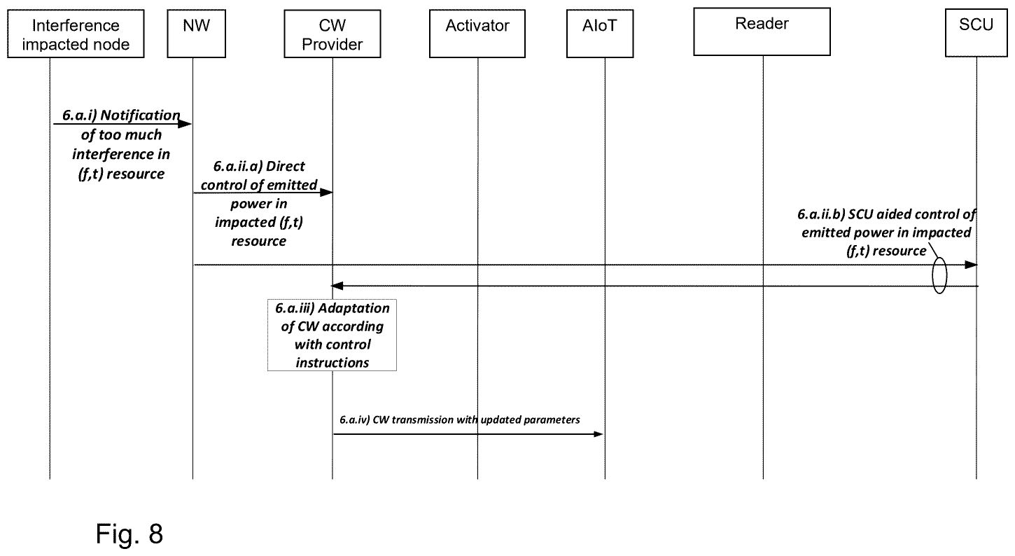

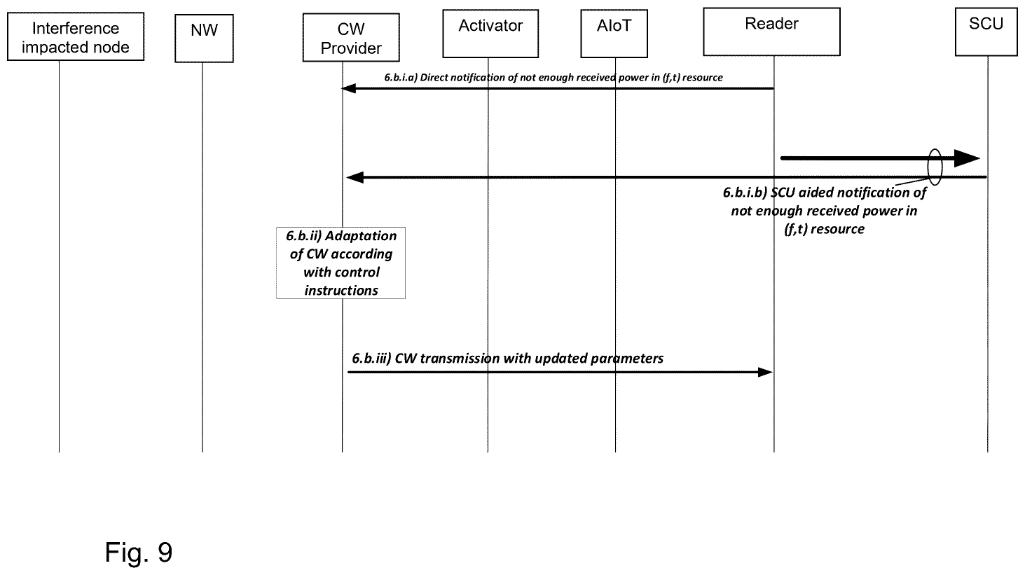

FIGS. 8 and 9 show embodiments B and C, according to which CW transmission characteristics are adapted.

In general, such an adaptation of the CW transmission characteristics is referred to as process 6.

According to embodiment B, the CW transmission characteristics are adapted based on an interference notification, as described above and shown in FIG. 8.

In process 6.a.i), a notification by an interference impacted node (an impacted UE or NW entity) regarding interference experienced due to a CW provider transmission is issued to a NW entity or SCU. This notification includes information about:
the received interference power and the suggested power reduction;
past time and frequency resources where this interference has been observed; and/or
future time and frequency resources where this interference level should be avoided.

In process 6.a.ii.a) or process 6.a.ii.b), a request to control of the CW provider transmission characteristics based on the interference notification is provided.

This request can be provided via the SCU that is responsible for the CW provider orchestration (which assumes that the node impacted with interference provides the interference notification to the SCU), as it is shown in process 6.a.ii.b). That is, the NW entity (e.g. the one serving the impacted UE) forwards the request to the SCU, which turn forwards it to the CW provider identified by the request.

Alternatively, this request can be provided directly from the NW entity (e.g. the one serving the impacted UE) towards the CW provider, as shown in process 6.a.ii.a). This assumes that the CW provider can be reached by the NW entity either via Uu (when the CW provider is a UE) or Xn interface (when the CW provider is a network element).

This control request can be provided directly from the impacted UE to the UE serving a CW provider when it is possible to establish a sidelink between these UEs.

As shown in process 6.a.iii), a control of the CW transmission characteristics is carried out in order to minimize the interference impact. The applied control to the transmission characteristics can be:
backoff of the transmission power according with the notification request;
avoidance of the time and frequency resources indicated in the interference notification (e.g. alteration or muting of the relevant hops in the frequency hopping pattern); and/or
deactivation or power backoff in the beamformers associated with the direction of the interference impacted node.

Thereafter, a transmission of the CW signal with the updated parameters is carried out, as shown in process 6.a.iv).

In the following, FIG. 9 is described which illustrates embodiment C, according to which CW transmission characteristics are adapted due to a too weak CW signal.

As shown in process 6.b.i.a) or 6.b.i.b), the reader issues a notification that it is not able to receive a strong enough CW signal and therefore the backscattered signal is also too weak to be decoded. This notification includes a request to control of the CW provider transmission characteristics based on the too weak signal notification. It is noted that, alternatively, the notification and the request can be two separate messages.

As shown in process 6.b.i.a), this request (control order) can be provided directly from the impacted UE to the UE serving a CW provider when it is possible to establish a sidelink between these UEs (according with the configuration details in Embodiment A).

Alternatively, as shown in process 6.b.i.b), this request (control order) can be provided via the SCU that is responsible for the CW provider orchestration, where the notification is provided to the SCU (following the configuration details in Embodiment A). The SCU forwards the notification to the CW provider.

In process 6.b.ii), a control of the CW transmission characteristics in order to increase the received CW signal. The applied control to the transmission characteristics can be:
ramp-up of the transmission power according with the notification request;
ramp-up of the power in the time and frequency resources indicated in the weak signal notification; and/or
ramp-up of the transmission power in the beamformers associated with the direction of the interference impacted node.

Thereafter, a transmission of the CW signal with the updated parameters is carried out, as shown in process 6.b.iii).

The above-described example embodiments are only examples and may be modified.

For example, some of the example embodiments described above illustrate an UE as a network element which is impacted by interference caused by the CW transmission from the CW provider. However, the network element is not limited to a UE, and can be any kind of network element which is impacted by the interference caused by the CW transmission. For example, such a network element may also be a base station or the like.

Names of network elements, protocols, and methods are based on current standards. In other versions or other technologies, the names of these network elements and/or protocols and/or methods may be different, as long as they provide a corresponding functionality.

In general, example embodiments may be implemented by computer software stored in the memory (memory resources, memory circuitry) 12, 22, 32, 42, 42 and executable by the processor (processing resources, processing circuitry) 11, 21, 31, 41, 51 or by hardware, or by a combination of software and/or firmware and hardware.

The terms “connected,” “coupled,” or any variant thereof, mean any connection or coupling, either direct or indirect, between two or more elements, and may encompass the presence of one or more intermediate elements between two elements that are “connected” or “coupled” together. The coupling or connection between the elements can be physical, logical, or a combination thereof. As employed herein two elements may be considered to be “connected” or “coupled” together by the use of one or more wires, cables and printed electrical connections, as well as by the use of electromagnetic energy, such as electromagnetic energy having wavelengths in the radio frequency region, the microwave region and the optical (both visible and invisible) region, as non-limiting examples.

The memory (memory resources, memory circuitry) 12, 22, 32, 42, 52 may be of any type suitable to the local technical environment and may be implemented using any suitable data storage technology, such as semiconductor based memory devices, magnetic memory devices and systems, optical memory devices and systems, fixed memory and removable memory, and non-transitory computer-readable media. The processor (processing resources, processing circuitry) 11, 21, 31, 41, 51 may be of any type suitable to the local technical environment, and may include one or more of general purpose computers, special purpose computers, microprocessors, digital signal processors (DSPs) and processors based on a multi core processor architecture, as non-limiting examples.

Further, as used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular network device, or other computing or network device.

The term “non-transitory”, as used herein, is a limitation of the medium itself (i.e., tangible, not a signal) as opposed to a limitation on data storage persistency (e.g., RAM vs. ROM).

It is noted that, as used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

It is to be understood that the various example embodiments of the subject disclosure are illustrative and non-limiting and are not intended to be construed as limiting. Various modifications and applications may be apparent to those skilled in the art without departing from the spirit and scope of the various example embodiments of the subject disclosure.

Among others, the following Items are covered by the above disclosure:
Item 1. An apparatus comprising
at least one processor, and
at least one memory storing instructions that, when executed by the at least one processor, cause the apparatus at least to:
associate a carrier wave provider with an ambient internet of things session, wherein the carrier wave provider is a network node configured to transmit a carrier wave, and the ambient internet of things session involves an ambient internet of things device being a network node configured to receive the carrier wave and manipulate the carrier wave transmitted by the carrier wave provider, and
provide notification information to at least one network node involved in the ambient internet of things session, wherein the notification information indicates how to interact with the associated carrier wave provider for transmitting control information to the associated carrier wave provider.
Item 2. The apparatus according to item 1, wherein, the instructions, when executed by the at least one processor, cause the apparatus at least to: provide an identifier identifying the carrier wave provider associated with the ambient internet of things session to the at least one network node involved in the ambient internet of things session.
Item 3. The apparatus according to item 1 or 2, wherein the instructions, when executed by the at least one processor, cause the apparatus at least to:
determine the carrier wave provider to be associated to the ambient internet of things session from a plurality of carrier wave providers based on proximity between the carrier wave provider and the ambient internet of things device.
Item 4. The apparatus according to item 1 or 2, wherein the instructions, when executed by the at least one processor, cause the apparatus at least to:
configure the notification configuration as an indirect connection to the carrier wave provider via the apparatus.
Item 5. The apparatus according to item 1 or 2, wherein the instructions, when executed by the at least one processor, cause the apparatus at least to:
configure the notification configuration as a direct connection to the carrier wave provider.
Item 6. The apparatus according to item 5, wherein the instructions, when executed by the at least one processor, cause the apparatus at least to:
configure a dedicated sidelink configuration as the direct connection to the carrier wave provider.
Item 7. The apparatus according to any one of the items 1 to 6, wherein the control information comprise at least one of power control information, frequency hopping control information, transmission beamforming information and duty cycle information.
Item 8. The apparatus according to any one of the items 1 to 7, wherein the instructions, when executed by the at least one processor, cause the apparatus at least to:
receive a notification from a reader, which is a network node configured to receive the manipulated carrier wave and which is involved in the ambient internet of things session, that received power from the ambient internet of things device involved in the ambient internet of things session is below a predetermined threshold, and
request the carrier wave provider to control a transmission characteristic of the carrier wave such that the received power is increased.
Item 9. The apparatus according to any one of the items 1 or 3 to 8, wherein the instructions, when executed by the at least one processor, cause the apparatus at least to:
provide information enabling to notify the session control unit or the carrier wave provider concerning a carrier wave transmission and carrier wave transmission information for identifying a carrier wave transmission, to at least one network node outside the ambient internet of things session.
Item 10. The apparatus according to item 9, wherein the carrier wave transmission information comprises information indicating a carrier wave transmission signature or an identifier identifying the carrier wave provider associated with the ambient internet of things session.
Item 11. The apparatus according to item 9 or 10, wherein the instructions, when executed by the at least one processor, cause the apparatus at least to:
receive a notification from the at least one network node outside the ambient internet of things session concerning a carrier wave transmission of the carrier wave provider, and
request the carrier wave provider to control a carrier wave transmission characteristic based on the received notification from the network node.
Item 12. The apparatus according to item 11, wherein the notification may comprise information for identifying the carrier wave provider.
Item 13. The apparatus according to item 12, wherein the information for identifying the carrier wave provider comprises information identifying a carrier wave signal signature transmitted by the carrier wave provider.
Item 14. The apparatus according to any one of the items 11 to 13, wherein the notification comprises at least one of
information concerning a suggested adaptation of the carrier wave transmission characteristic,
information on interference caused by the carrier wave transmission,
information concerning timing at which interference should be avoided, or
information concerning traffic priority.
Item 15. An apparatus, comprising
at least one processor, and
at least one memory storing instructions that, when executed by the at least one processor, cause the apparatus at least to:
transmit a carrier wave for an ambient internet of things session involving an ambient internet of things device being a network node configured to receive the carrier wave and manipulate the carrier wave,
receive a request for controlling at least one carrier wave transmission characteristic such that the at least one carrier wave transmission characteristic is changed, and
control the at least one carrier wave transmission characteristic based on the received request.
Item 16. The apparatus according to item 15, wherein
the request is a request for controlling the at least one carrier wave transmission characteristic such that an interference caused by the carrier wave transmission is decreased, and
the instructions, when executed by the at least one processor, cause the apparatus at least to:
receive the request from
   a session control unit controlling the ambient internet of things session or from a network node outside the ambient internet of things session.
Item 17. The apparatus according to item 16, wherein the instructions, when executed by the at least one processor, cause the apparatus at least to:
receive the request from the network node outside the ambient internet of things session via a dedicated sidelink configuration as the direct connection.
Item 18. The apparatus according to item 15, wherein
the request is a request for increasing a transmission power, and
the instructions, when executed by the at least one processor, cause the apparatus at least to:
receive the request from
   a session control unit controlling the ambient internet of things session or from the reader involved in the ambient internet of things session.
Item 19. The apparatus according to item 18, wherein the instructions, when executed by the at least one processor, cause the apparatus at least to:
receive the request from the reader involved in the ambient internet of things session via a dedicated sidelink configuration.
Item 20. The apparatus according to any one of the items 15 to 19, wherein the request for controlling the at least one carrier wave transmission characteristic comprises at least one of power control information, frequency hopping control information, transmission beamforming information and duty cycle information.
Item 21. An apparatus, comprising
at least one processor, and
at least one memory storing instructions that, when executed by the at least one processor, cause the apparatus at least to:
receive a carrier wave transmission modulated by an ambient internet of things device in an ambient internet of things session,
determine whether a received power of the carrier wave transmission is below a predetermined threshold; and
in response to determination that the received power is below the predetermined threshold, prepare a notification requesting to control at least one carrier wave transmission characteristic such that the received power is increased, and transmit the notification to a carrier wave provider transmitting the carrier wave transmission or to a session control unit controlling the ambient internet of things session.
Item 22. The apparatus according to item 21, wherein the instructions, when executed by the at least one processor, cause the apparatus at least to:
transmit the notification to the carrier wave provider transmitting the carrier wave transmission based on an identifier of the carrier wave provider provided by the session control unit.
Item 23. The apparatus according to item 21 or 22, wherein the instructions, when executed by the at least one processor, cause the apparatus at least to:
transmit the notification to the carrier wave provider transmitting the carrier wave transmission via a dedicated sidelink configuration.
Item 24. The apparatus according to any one of the items 21 to 23, wherein the notification requesting to control the at least one carrier wave transmission characteristic such that the received power is increased comprises at least one of power control information, frequency hopping control information, transmission beamforming information and duty cycle information.
Item 25. An apparatus, comprising
at least one processor, and
at least one memory storing instructions that, when executed by the at least one processor, cause the apparatus at least to:
obtain information, from a session control unit controlling a ambient internet of things session, which enables notifying the session control unit or a carrier wave provider involved in controlling the ambient internet of things session concerning a carrier wave transmission, and identifying the carrier wave transmission, and
provide the obtained information to at least one network node, wherein the at least one network node is under control of said apparatus.
Item 26. The apparatus according to item 25, wherein information for identifying the session control unit is provided in a radio resource control configuration.
Item 27. The apparatus according to item 25 or 26, wherein the information enabling to notify the session control unit comprises information concerning a dedicated scheduling request/physical uplink control channel configuration to be used for a notification and/or information that the notification can be provided via a random access channel procedure.
Item 28. The apparatus according to any one of the items 25 to 27, wherein
a plurality of network nodes is under control of said apparatus, and
the instructions, when executed by the at least one processor, cause the apparatus at least to:
transmit the information to all network nodes controlled by the apparatus; or
determine at least one potentially interference impacted network node of the plurality of network nodes, which is potentially affected by interference caused by the carrier wave transmission of the carrier wave provider, based on location information of the at least one potentially interference impacted network node and the carrier wave provider, and transmit the information to the determined at least one potentially interference impacted network node.
Item 29. The apparatus according to any one of the items 25 to 27, wherein the instructions, when executed by the at least one processor, cause the apparatus at least to:
receive information from the at least one network node that interference is caused by the carrier wave transmission of the carrier wave provider, and
transmit a notification to the carrier wave provider or the session control unit.
Item 30. The apparatus according to item 29, wherein the notification comprises at least one of
information concerning a suggested control of at least one carrier wave transmission characteristic,
information on interference caused by the carrier wave transmission,
information concerning timing at which interference should be avoided, or
information concerning traffic priority.
Item 31. An apparatus, comprising
at least one processor, and
at least one memory storing instructions that, when executed by the at least one processor, cause the apparatus at least to:
obtain information from a session control unit controlling a ambient internet of things session, which enables notifying the session control unit or a carrier wave provider involved in controlling the ambient internet of things session concerning a carrier wave transmission, and identifying the carrier wave transmission,
detect interference affecting the apparatus caused by the carrier wave transmission, and
transmit a notification concerning the detected interference to the carrier wave provider or the session control unit based on the obtained information.
Item 32. The apparatus according to item 31, wherein the notification concerning the detected interference comprises at least one of
information concerning a suggested control of the at least one carrier wave transmission characteristic,
information on interference caused by the carrier wave transmission,
information concerning timing at which interference should be avoided, or
information concerning traffic priority.
Item 33. The apparatus according to item 31 or 32, wherein information for identifying the session control unit is provided in a radio resource control configuration.
Item 34. The apparatus according to any one of the items 26 to 28, wherein the information enabling to notify the session control unit comprises information concerning a dedicated scheduling request/physical uplink control channel configuration to be used for a notification and/or information that the notification can be provided via a random access channel procedure.
Item 35. The apparatus according to any one of the items 1 to 34, wherein the at least one carrier wave transmission characteristic comprises transmission power, frequency hopping and/or transmission beamforming.
Item 36. A method comprising
associating a carrier wave provider with an ambient internet of things session, wherein the carrier wave provider is a network node configured to transmit a carrier wave, and the ambient internet of things session involves an ambient internet of things device being a network node configured to receive the carrier wave and manipulate the carrier wave transmitted by the carrier wave provider, and
providing notification information to at least one network node involved in the ambient internet of things session, wherein the notification information indicates how to interact with the associated carrier wave provider for transmitting control information to the associated carrier wave provider.
Item 37. The method according to item 36, further comprising:
providing an identifier identifying the carrier wave provider associated with the ambient internet of things session to the at least one network node involved in the ambient internet of things session.
Item 38. The method according to item 36 or 37, further comprising:
determining the carrier wave provider to be associated to the ambient internet of things session from a plurality of carrier wave providers based on proximity between the carrier wave provider and the ambient internet of things device.
Item 39. The method according to item 36 or 37, further comprising:
configuring the notification configuration as an indirect connection to the carrier wave provider via a network element carrying out the method.
Item 40. The method according to item 36 or 37, further comprising:
configuring the notification configuration as a direct connection to the carrier wave provider.
Item 41. The method according to item 40, further comprising:
configuring a dedicated sidelink configuration as the direct connection to the carrier wave provider.
Item 42. The method according to any one of the items 36 to 41, wherein the control information comprise at least one of power control information, frequency hopping control information, transmission beamforming information and duty cycle information.
Item 43. The method according to any one of the items 36 to 42, further comprising:
receiving a notification from a reader, which is a network node configured to receive the manipulated carrier wave and which is involved in the ambient internet of things session, that received power from the ambient internet of things device involved in the ambient internet of things session is below a predetermined threshold, and
requesting the carrier wave provider to control a transmission characteristic of the carrier wave such that the received power is increased.
Item 44. The method according to any one of the items 36 or 38 to 43, further comprising:
providing information enabling to notify the session control unit or the carrier wave provider concerning a carrier wave transmission and carrier wave transmission information for identifying a carrier wave transmission, to at least one network node outside the ambient internet of things session.
Item 45. The method according to item 44, wherein the carrier wave transmission information comprises information indicating a carrier wave transmission signature or an identifier identifying the carrier wave provider associated with the ambient internet of things session.
Item 46. The method according to item 44 or 45, further comprising:
receiving a notification from the at least one network node outside the ambient internet of things session concerning a carrier wave transmission of the carrier wave provider, and
requesting the carrier wave provider to control a carrier wave transmission characteristic based on the received notification from the network node.
Item 47. The method according to item 46, wherein the notification may comprise information for identifying the carrier wave provider.
Item 48. The method according to item 47, wherein the information for identifying the carrier wave provider comprises information identifying a carrier wave signal signature transmitted by the carrier wave provider.
Item 49. The method according to any one of the items 46 to 48, wherein the notification comprises at least one of
information concerning a suggested adaptation of the carrier wave transmission characteristic,
information on interference caused by the carrier wave transmission,
information concerning timing at which interference should be avoided, or
information concerning traffic priority.
Item 50. A method comprising:
transmitting a carrier wave for an ambient internet of things session involving an ambient internet of things device being a network node configured to receive the carrier wave and manipulate the carrier wave,
receiving a request for controlling at least one carrier wave transmission characteristic such that the at least one carrier wave transmission characteristic is changed, and
controlling the at least one carrier wave transmission characteristic based on the received request.
Item 51. The method according to item 50, wherein
the request is a request for controlling the at least one carrier wave transmission characteristic such that an interference caused by the carrier wave transmission is decreased, and
the method further comprises:
receiving the request from
   a session control unit controlling the ambient internet of things session, or from a network node outside the ambient internet of things session.
Item 52. The method according to item 51, further comprising:
receive the request from the network node outside the ambient internet of things session via a dedicated sidelink configuration as the direct connection.
Item 53. The method according to item 50, wherein
the request is a request for increasing a transmission power, and
the method further comprises:
receiving the request from
   a session control unit controlling the ambient internet of things session or from the reader involved in the ambient internet of things session.
Item 54. The method according to item 53, further comprising:
receiving the request from the reader involved in the ambient internet of things session via a dedicated sidelink configuration.
Item 55. The method according to any one of the items 50 to 54, wherein the request for controlling the at least one carrier wave transmission characteristic comprises at least one of power control information, frequency hopping control information, transmission beamforming information and duty cycle information.
Item 56. A method comprising:
receiving a carrier wave transmission modulated by an ambient internet of things device in an ambient internet of things session,
determining whether a received power of the carrier wave transmission is below a predetermined threshold; and
in response to determination that the received power is below the predetermined threshold, preparing a notification requesting to control at least one carrier wave transmission characteristic such that the received power is increased, and transmitting the notification to a carrier wave provider transmitting the carrier wave transmission or to a session control unit controlling the ambient internet of things session.
Item 57. The method according to item 56, further comprising:
transmitting the notification to the carrier wave provider transmitting the carrier wave transmission based on an identifier of the carrier wave provider provided by the session control unit.
Item 58. The method according to item 56 or 57, further comprising:
transmit the notification to the carrier wave provider transmitting the carrier wave transmission via a dedicated sidelink configuration.
Item 59. The method according to any one of the items 56 to 58, wherein the notification requesting to control the at least one carrier wave transmission characteristic such that the received power is increased comprises at least one of power control information, frequency hopping control information, transmission beamforming information and duty cycle information.
Item 60. A method comprising:
obtaining information, from a session control unit controlling a ambient internet of things session, which enables notifying the session control unit or a carrier wave provider involved in controlling the ambient internet of things session concerning a carrier wave transmission, and identifying the carrier wave transmission, and
providing the obtained information to at least one network node, wherein the at least one network node is under control of a network control element carrying out the method.
Item 61. The method according to item 60, wherein information for identifying the session control unit is provided in a radio resource control configuration.
Item 62. The method according to item 60 or 61, wherein the information enabling to notify the session control unit comprises information concerning a dedicated scheduling request/physical uplink control channel configuration to be used for a notification and/or information that the notification can be provided via a random access channel procedure.
Item 63. The method according to any one of the items 60 to 62, wherein
a plurality of network nodes is under control of the network control element carrying out the method, and
the method further comprises:
transmitting the information to all network nodes controlled by the network control element; or
determining at least one potentially interference impacted network node of the plurality of network nodes, which is potentially affected by interference caused by the carrier wave transmission of the carrier wave provider, based on location information of the at least one potentially interference impacted network node and the carrier wave provider, and transmitting the information to the determined at least one potentially interference impacted network node.
Item 64. The method according to any one of the items 61 to 63, further comprising:
receiving information from the at least one network node that interference is caused by the carrier wave transmission of the carrier wave provider, and
transmitting a notification to the carrier wave provider or the session control unit.
Item 65. The method according to item 64, wherein the notification comprises at least one of
information concerning a suggested control of at least one carrier wave transmission characteristic,
information on interference caused by the carrier wave transmission,
information concerning timing at which interference should be avoided, or
information concerning traffic priority.
Item 66. A method, comprising:
obtaining information from a session control unit controlling a ambient internet of things session, which enables notifying the session control unit or a carrier wave provider involved in controlling the ambient internet of things session concerning a carrier wave transmission, and identifying the carrier wave transmission,
detecting interference affecting a network node carrying out the method, which is caused by the carrier wave transmission, and
transmitting a notification concerning the detected interference to the carrier wave provider or the session control unit based on the obtained information.
Item 67. The method according to item 66, wherein the notification concerning the detected interference comprises at least one of
information concerning a suggested control of the at least one carrier wave transmission characteristic,
information on interference caused by the carrier wave transmission,
information concerning timing at which interference should be avoided, or
information concerning traffic priority.
Item 68. The method according to item 66 or 67, wherein information for identifying the session control unit is provided in a radio resource control configuration.
Item 69. The method according to any one of the items 66 to 68, wherein the information enabling to notify the session control unit comprises information concerning a dedicated scheduling request/physical uplink control channel configuration to be used for a notification and/or information that the notification can be provided via a random access channel procedure.
Item 70. The method according to any one of the items 36 to 69, wherein the at least one carrier wave transmission characteristic comprises transmission power, frequency hopping and/or transmission beamforming.
Item 71. A computer program product comprising code means for performing a method according to any one of the items 35 to 70 when run on a processing means or module.
Item 72. The computer program product according to item 72, wherein the computer program product is embodied on a computer-readable medium, and/or the computer program product is directly loadable into the internal memory of the computer and/or transmittable via a network by means of at least one of upload, download and push procedures.
Item 73. An apparatus comprising
means for associating a carrier wave provider with an ambient internet of things session, wherein the carrier wave provider is a network node for transmitting a carrier wave, and the ambient internet of things session involves an ambient internet of things device being a network node for receiving the carrier wave and for manipulating the carrier wave transmitted by the carrier wave provider, and
means for providing notification information to at least one network node involved in the ambient internet of things session, wherein the notification information indicates how to interact with the associated carrier wave provider for transmitting control information to the associated carrier wave provider.
Item 74. An apparatus comprising:
means for transmitting a carrier wave for an ambient internet of things session involving an ambient internet of things device being a network node configured to receive the carrier wave and manipulate the carrier wave,
means for receiving a request for controlling at least one carrier wave transmission characteristic such that the at least one carrier wave transmission characteristic is changed, and
means for controlling the at least one carrier wave transmission characteristic based on the received request.
Item 75. An apparatus:
means for receiving a carrier wave transmission modulated by an ambient internet of things device in an ambient internet of things session,
means for determining whether a received power of the carrier wave transmission is below a predetermined threshold; and
means for, in response to determination that the received power is below the predetermined threshold, preparing a notification requesting to control at least one carrier wave transmission characteristic such that the received power is increased, and transmitting the notification to a carrier wave provider transmitting the carrier wave transmission or to a session control unit controlling the ambient internet of things session.
Item 76. An apparatus comprising:
means for obtaining information, from a session control unit controlling a ambient internet of things session, which enables notifying the session control unit or a carrier wave provider involved in controlling the ambient internet of things session concerning a carrier wave transmission, and identifying the carrier wave transmission, and
means for providing the obtained information to at least one network node, wherein the at least one network node is under control of said apparatus.
Item 77. An apparatus, comprising:
means for obtaining information from a session control unit controlling a ambient internet of things session, which enables notifying the session control unit or a carrier wave provider involved in controlling the ambient internet of things session concerning a carrier wave transmission, and identifying the carrier wave transmission,
means for detecting interference affecting the apparatus caused by the carrier wave transmission, and
means for transmitting a notification concerning the detected interference to the carrier wave provider or the session control unit based on the obtained information.

1. An apparatus, comprising
at least one processor, and
at least one memory storing instructions that, when executed by the at least one processor, cause the apparatus at least to:
receive a carrier wave transmission modulated by an ambient internet of things device in an ambient internet of things session,
determine whether a received power of the carrier wave transmission is below a predetermined threshold; and
in response to determination that the received power is below the predetermined threshold, prepare a notification requesting to control at least one carrier wave transmission characteristic such that the received power is increased, and transmit the notification to a carrier wave provider transmitting the carrier wave transmission or to a session control unit controlling the ambient internet of things session.

2. The apparatus according to claim 1, wherein the instructions, when executed by the at least one processor, cause the apparatus at least to:
transmit the notification to the carrier wave provider transmitting the carrier wave transmission based on an identifier of the carrier wave provider provided by the session control unit.

3. The apparatus according to claim 1, wherein the instructions, when executed by the at least one processor, cause the apparatus at least to:
transmit the notification to the carrier wave provider transmitting the carrier wave transmission via a dedicated sidelink configuration.

4. The apparatus according to claim 1, wherein the notification requesting to control the at least one carrier wave transmission characteristic such that the received power is increased comprises at least one of power control information, frequency hopping control information, transmission beamforming information and duty cycle information.

5. The apparatus according to claim 1, wherein the at least one carrier wave transmission characteristic comprises transmission power, frequency hopping and/or transmission beamforming.

6. A method comprising:
receiving a carrier wave transmission modulated by an ambient internet of things device in an ambient internet of things session,
determining whether a received power of the carrier wave transmission is below a predetermined threshold; and
in response to determination that the received power is below the predetermined threshold, preparing a notification requesting to control at least one carrier wave transmission characteristic such that the received power is increased, and transmitting the notification to a carrier wave provider transmitting the carrier wave transmission or to a session control unit controlling the ambient internet of things session.

7. The method according to claim 6, further comprising:
transmitting the notification to the carrier wave provider transmitting the carrier wave transmission based on an identifier of the carrier wave provider provided by the session control unit.

8. The method according to claim 6, further comprising:
transmit the notification to the carrier wave provider transmitting the carrier wave transmission via a dedicated sidelink configuration.

9. The method according to claim 6, wherein the notification requesting to control the at least one carrier wave transmission characteristic such that the received power is increased comprises at least one of power control information, frequency hopping control information, transmission beamforming information and duty cycle information.

10. The method according to claim 6, wherein the at least one carrier wave transmission characteristic comprises transmission power, frequency hopping and/or transmission beamforming.

11. A non-transitory computer readable medium comprising code for performing the method according to claim 6 when run on a processor.

12. The non-transitory computer readable medium according to claim 11, wherein the code is embodied on a non-transitory computer-readable medium, and/or the code is directly loadable into an internal memory of a computer and/or transmittable via a network by at least one of upload, download and push procedures.

13-17. (canceled)
